(19) United States
(12) Patent Application Publication
(10) Pub. No.: US 2010/0333140 A1
(43) Pub. Date: Dec. 30, 2010

(54) DISPLAY PROCESSING APPARATUS, DISPLAY PROCESSING METHOD, AND COMPUTER PROGRAM PRODUCT

(76) Inventors: Mieko Onodera, Kanagawa (JP); Yoshihisa Kizuka, Tokyo (JP); Hitoshi Saijo, Tokyo (JP); Sayoko Tanaka, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/700,301

(22) Filed: Feb. 4, 2010

(30) Foreign Application Priority Data
Jun. 29, 2009 (JP) 2009-153897

(51) Int. Cl. H04N 5/445

(52) U.S. Cl. 725/44; 725/53

(57) ABSTRACT

According to one embodiment, an display processing apparatus includes an operation receiver, a relation calculator, a keyword extractor, a display information generator, and a display controller. The operation receiver receives operation to select key content. The relation calculator calculates the relation of second contents to the key content. The keyword extractor extracts a common keyword contributing to the relation from an item related to the calculation of the relation. The display information generator generates first display information of the key content and second display information of the second contents, and keyword display information indicating the common keyword. The display controller displays list information, in which pieces of the second display information are arranged such that second display information of second content with higher relation to the key content is closer to the first display information. The display controller displays the keyword display information in association with the second display information.

### CROSS-REFERENCE TO RELATED APPLICATIONS

This application is based upon and claims the benefit of priority from Japanese Patent Application No. 2009-153897, filed Jun. 29, 2009, the entire contents of which are incorporated herein by reference.

### BACKGROUND

1. Field

One embodiment of the invention relates to a display processing apparatus, a display processing method, and a computer program product.

2. Description of the Related Art

In recent years, with increased capability of AV equipment for storing contents and improved seamless accessibility of contents between equipment, let alone within the same equipment, or on a network, there has been a proliferation in the number of contents accessible to users. Accordingly, for example, Japanese Patent Application Publication (KOKAI) No. 2001-292383 discloses a conventional receiving device that allows users to select and view such contents.

With the conventional receiving device, in response to user selection of content from a list of contents, the content desired by the user is displayed. When the content selected by the user is stored in the device, the content is read and displayed on its data display module. On the other hand, when the content is present outside the device, the content is received from the outside and displayed on the data display module.

Besides, a recent increase in the capacity of storage media such as hard disk drive (HDD) provided to AV equipment increases video audio data (contents) stored in the storage media. This increases steps to retrieve video audio data (contents) that a user desires to view. If what is to be displayed includes video audio data (contents) on a network, then, the number of search objects further increases.

Thus, there is a need for a technology that facilitates the retrieval of video audio data (content) desired by a user from various types of contents.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a display processing apparatus according to a first embodiment of the invention;

FIG. 2 is an exemplary schematic diagram of metadata when a television (TV) program is content in the first embodiment;

FIG. 3 is an exemplary schematic diagram for explaining a common keyword in the first embodiment;

FIG. 4A is an exemplary schematic diagram of standard mode display information in the first embodiment;

FIG. 4B is another exemplary schematic diagram of standard mode display information in the first embodiment;

FIG. 4C is an exemplary schematic diagram of search mode display information in the first embodiment;

FIG. 4D is an exemplary schematic diagram of search mode display information in the first embodiment;

FIG. 5A is an exemplary schematic diagram for explaining the operation of displaying the display information in the first embodiment;

FIG. 5B is another exemplary schematic diagram for explaining the operation of displaying the display information in the first embodiment;

FIG. 6 is still another exemplary schematic diagram for explaining the operation of displaying the display information in the first embodiment;

FIG. 7 is still another exemplary schematic diagram for explaining the operation of displaying the display information in the first embodiment;

FIG. 8 is still another exemplary schematic diagram for explaining the operation of displaying the display information in the first embodiment;

FIG. 9 is still another exemplary schematic diagram for explaining the operation of displaying the display information in the first embodiment;

FIG. 10 is an exemplary schematic diagram of list information in which are arranged standard mode display information of key content and that of other contents in the first embodiment;

FIG. 11 is an exemplary schematic diagram of list information in which are arranged search mode display information of key content and that of other contents in the first embodiment;

FIG. 12 is an exemplary flowchart of the process of displaying the display information performed by the display processing apparatus in the first embodiment;

FIG. 13A is an exemplary schematic diagram of display information according to a modification of the first embodiment;

FIG. 13B is an exemplary schematic diagram of display information according to the modification;

FIG. 14 is an exemplary schematic diagram of search mode list information and keyword display information according to a second embodiment of the invention; and

FIG. 15 is another exemplary schematic diagram of search mode list information and keyword display information in the second embodiment.

### DETAILED DESCRIPTION

Various embodiments according to the invention will be described hereinafter with reference to the accompanying drawings. In general, according to one embodiment of the invention, a display processing apparatus comprises an operation receiver, a relation calculator, a keyword extractor, a display information generator, and a display controller. The operation receiver is configured to receive operation to select key content of a first type as a search key. The relation calculator is configured to calculate the relation of each of second contents to the key content. The second contents are of a plurality of types including a second type different from the first type. The keyword extractor is configured to extract a common keyword contributing to the relation from an item related to the calculation of the relation with respect to each of the second contents. The display information generator is configured to generate first display information of the key content and second display information of each of the second contents, and keyword display information indicating the common keyword. The display controller is configured to display list information, in which pieces of the second display information are arranged such that second display information of second content with higher relation to the key content is closer to the first display information. The display controller is configured to display the keyword display information of each of the second contents in the list information in association with the second display information of the second content.

According to another embodiment of the invention, a computer program product comprises a computer usable medium having computer readable program codes embodied in the medium that, when executed, causes a computer to implement the above display processing apparatus.

According to still another embodiment of the invention, there is provided a display processing method applied to a display processing apparatus comprising a controller and a storage module. The display processing method is performed by the controller and comprises: an operation receiver receiving operation to select key content of a first type as a search key; a relation calculator calculating the relation of each of second contents to the key content, the second contents being of a plurality of types including a second type different from the first type; a keyword extractor extracting a common keyword contributing to the relation from an item related to the calculation of the relation with respect to each of the second contents; a display information generator generating first display information of the key content and second display information of each of the second contents, and keyword display information indicating the common keyword; and a display controller displaying list information, in which pieces of the second display information are arranged such that second display information of second content with higher relation to the key content is closer to the first display information. The display controller is configured to display the keyword display information of each of the second contents in the list information in association with the second display information of the second content.

Although a display processing apparatus of the embodiments is described below as being applied to a personal computer with a television (TV), this is by way of example only and is not to be construed to be limiting. The display processing apparatus may be applied to any display device capable of displaying video or the like. Briefly, in the following embodiments, when a user retrieves a key content as a search key and content related to the key content from a plurality of contents, the display processing apparatus displays the key content with contents related to the key content in response to user selection of the key content.

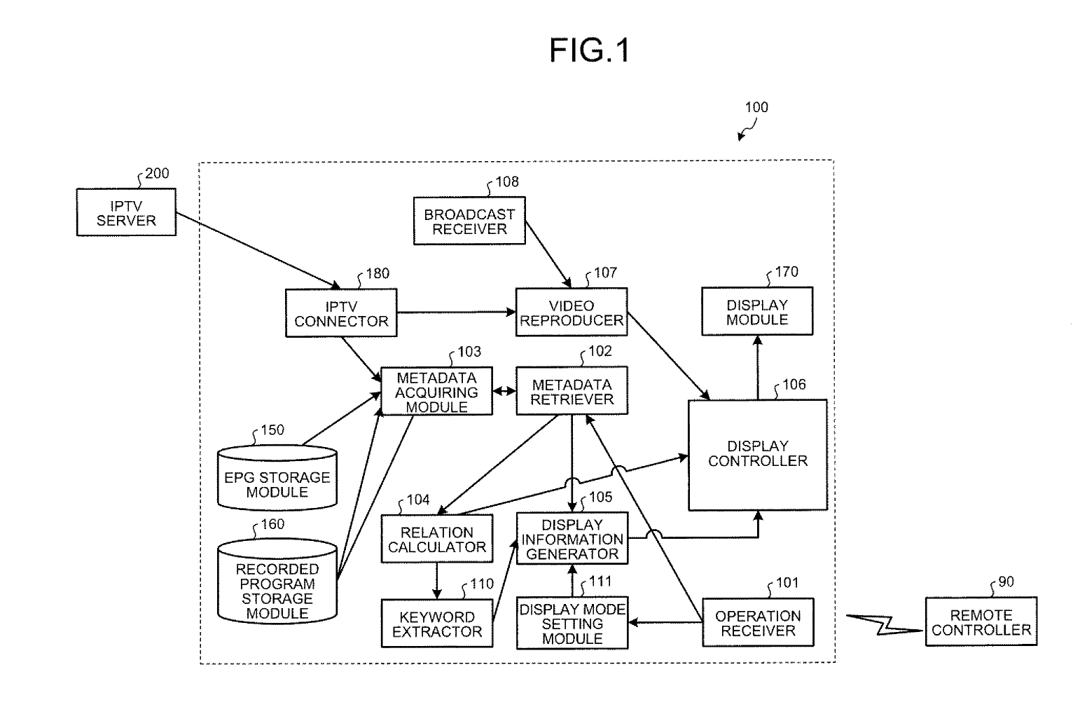

A first embodiment of the invention will now be described with reference to FIGS. 1 to 13B. First, a description will be given of the functional configuration of a display processing apparatus 100 according to the first embodiment. FIG. 1 is a block diagram of the display processing apparatus 100. As illustrated in FIG. 1, the display processing apparatus 100 comprises an electronic program guide (EPG) storage module 150, a recorded program storage module 160, a display module 170, a broadcast receiver 108, a video reproducer 107, and an Internet protocol television (IPTV) connector 180. The display processing apparatus 100 is connected to an IPTV server 200 via a network. Although not illustrated in the drawings, the display processing apparatus 100 further comprises a processor, such as an application-specific integrated circuit (ASIC) or a central processing unit (CPU), and a storage device. Examples of the storage device include a read only memory (ROM) that stores a predetermined computer program for controlling the display processing apparatus 100 and a random access memory (RAM) that provides a work area for the processor. The cooperation of the processor and the computer program stored in the storage device implements functional modules including the EPG storage module 150, the recorded program storage module 160, an operation receiver 101, a metadata retriever 102, a metadata acquiring module 103, a relation calculator 104, a display information generator 105, a display controller 106, the video reproducer 107, a keyword extractor 110, and a display mode setting module 111.

The IPTV server 200 provides services to distribute video such as TV programs and movies using IP. In response to a request from the display processing apparatus 100, the IPTV server 200 delivers thereto content such as the video and metadata of the content.

The IPTV connector 180 is an interface that connects between the display processing apparatus 100 and the IPTV server 200.

The EPG storage module 150 is a storage medium such as a hard disk drive (HDD) or a memory for storing an electronic program guide obtained from an external server that manages and distributes the electronic program guide. More specifically, the EPG storage module 150 obtains via a communication module (not illustrated) an electronic program guide for TV, cable television (CATV), communications satellite (CS) broadcasting, broadcasting satellite (BS) broadcasting, and the like from a service provider server connected through a network such as the Internet. Thus, the EPG storage module 150 stores the electronic program guide. It is assumed herein that the electronic program guide contains information on programs to be broadcasted during a period from the present time to a certain time in the future (e.g., after one week).

The recorded program storage module 160 is a storage medium such as HDD or memory for storing content such as video. For example, if the display processing apparatus 100 is TV with HDD, the recorded program storage module 160 stores video of a recorded TV program as the content. Examples of the content include video in a digital versatile disk (DVD) and video captured by a video camera.

The recorded program storage module 160 also stores metadata related to the content in association therewith. The term “metadata” as used herein refers to a set of information indicating unique characteristics of the content. The unique characteristics include the title of the content and the broadcast date and time of the content. For example, if the content is a TV program, the metadata indicates information (program information) on the TV program such as the title, the channel/broadcast date and time, the cast, the brief description (subtitle), and the genre. This metadata is provided to the recorded program storage module 160 with the content and stored therein in association with the content.

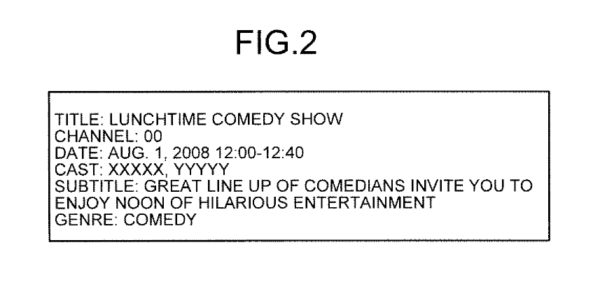

FIG. 2 illustrates the metadata when a TV program is the content. The metadata illustrated in FIG. 2 represents information related to the content of a recorded TV program. The recorded program storage module 160 stores as metadata the information, such as the title of the TV program “Lunchtime Comedy Show”, the channel “00”, the broadcast date and time “Aug. 1, 2008, 12:00-12:40”, the cast “xxxxx, yyyyy”, the subtitle “Great line up of comedians invite you to enjoy a noon of hilarious entertainment”, and the genre “comedy”.

Although an example is described above in which the metadata is provided as being preset, this is by way of example and not of limitation. The recorded program storage module 160 may receive information provided by a user thorough an input device such as a remote controller 90 and store it as metadata in association with the content.

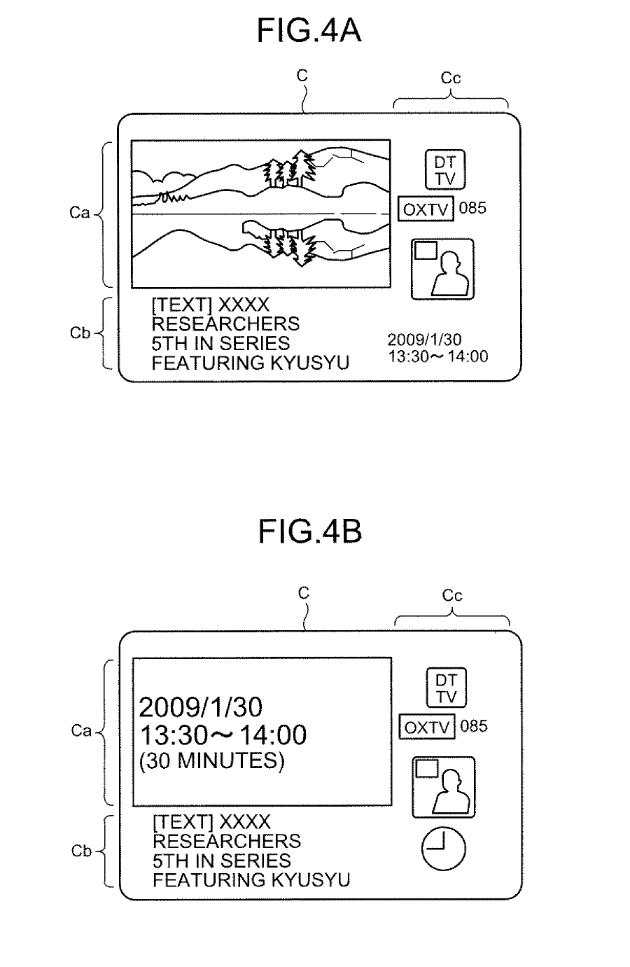

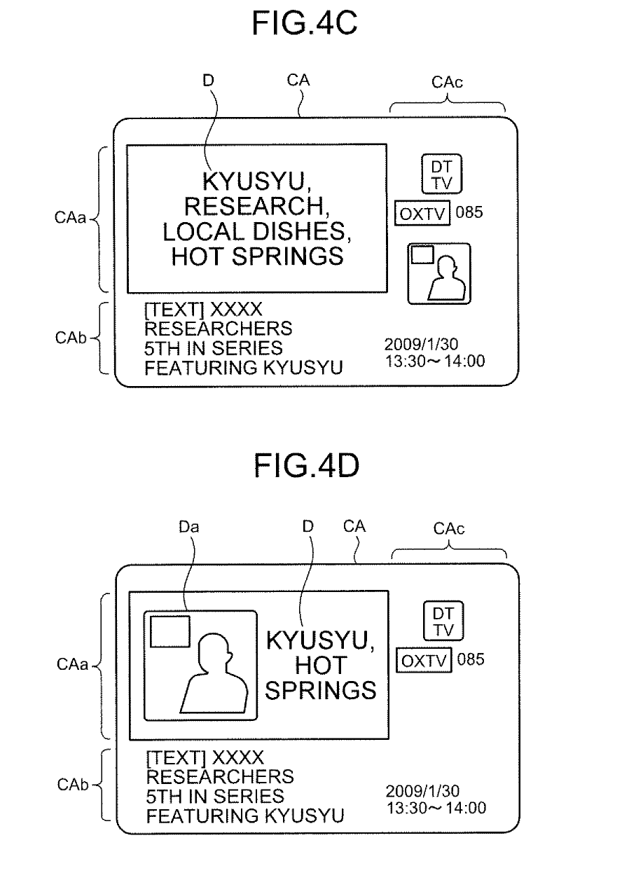

The display module 170 includes, for example, a liquid crystal display (LCD) for displaying text and an image, and displays content of a received TV program, stored content, an electronic program guide, and the like. The display module 170 also displays display information representing the details of content generated by the display information generator 105, which will be described later, to allow a user to retrieve the content (see FIGS. 4A to 4D).

The broadcast receiver 108 receives the content of video (TV program) broadcasted by TV broadcasting through an antenna or a cable (not illustrated).

The video reproducer 107 acquires the content of video that a user desires to reproduce. Examples of the content include the content of a TV program, etc. received by the broadcast receiver 108, the content of video acquired from the IPTV server 200 through the IPTV connector 180, and the content of video stored in the recorded program storage module 160. The video reproducer 107 decodes (reproduces) the content thus acquired, and outputs it to the display controller 106.

The operation receiver 101 receives user's operation. More specifically, when a user operates an input device, the operation receiver 101 recognizes the operation and receives an input provided by the operation. Examples of the input device include the remote controller 90 provided with operation buttons, a keyboard (not illustrated), and a mouse (not illustrated). The user's operation may be pressing an operation button on the remote controller 90, typing on the keyboard, moving the mouse or pressing the mouse button, and the like. For example, when a user retrieves desired content as well as contents related to the desired content from a plurality of contents, the user selects content (key content) as a search key using the input device from a plurality of contents of the electronic program guide displayed on the display module 170. The operation receiver 101 receives this selection of the key content. The key content may be content being reproduced. In this case, when a user operates the input device while content is being reproduced, the operation receiver 101 receives the user's operation as a selection of the key content, i.e., an instruction to retrieve contents. As will be described in detail later, the operation receiver 101 receives an instruction as to display information of focused content in list information displayed on the display module 170. The list information indicates pieces of display information of a plurality of contents.

The metadata acquiring module 103 acquires, when the operation receiver 101 receives selection operation for key content, meta data of all contents (the key content and other contents than the key content). More specifically, for example, the metadata acquiring module 103 acquires the metadata of the contents from the recorded program storage module 160. The metadata acquiring module 103 may request the IPTV server 200 for the metadata of the contents and acquire the metadata. The metadata acquiring module 103 may also acquire the metadata of the contents from the electronic program guide stored in the EPG storage module 150.

The metadata retriever 102 retrieves, when the operation receiver 101 receives selection operation for the key content, metadata of the key content from the metadata of the contents acquired by the metadata acquiring module 103. The metadata retriever 102 then outputs the metadata of the key content to the relation calculator 104. The metadata retriever 102 also retrieves, based on the metadata of the key content acquired from the metadata acquiring module 103, metadata of other contents to be the objects of calculation by the relation calculator 104 as to the relation to the metadata of the key content. The metadata retriever 102 then outputs the metadata of the other contents to the relation calculator 104.

The metadata retriever 102 also outputs, when the operation receiver 101 receives selection operation for the key content, the metadata of all the contents acquired by the metadata acquiring module 103 to the display information generator 105.

The relation calculator 104 calculates the relation of the other contents to the key content based on the metadata of the key content and the metadata of the other contents received from the metadata retriever 102 for each item contained in the metadata. Examples of the item include title and channel. More specifically, the relation calculator 104 calculates relation RM using the following Equation 1:

$$relation RM = {\sum }_{n - 1}^{N} {fa}_{n} ( M 11 ( n ) , M 21 ( n ) ) \times {wa}_{n} \qquad ( 1 )$$

where N represents the total number of metadata items acquirable by the metadata acquiring module 103, M11 represents the metadata of the key content, M21 represents the metadata of any of the other contents, and (n) represents n-th metadata acquired by the metadata acquiring module 103. Further, faₙ(M11 (n), M21 (n)) is a function that returns the relation between metadata M11 (n) and M21 (n) as RMₙ, and Waₙ is a value (n=1, . . . , N) indicating weight.

As described above, although various types of information is acquired as the metadata, the metadata will be described below as including a set of five items (N=5), i.e., recoding date and time, title of content, channel, genre, and cast, for simplicity. The five items of the metadata will be described as n=1, 2, . . . , 5 in the above order.

The relation RM of the other contents with respect to the key content can be represented by the weighted linear sum of the following five relations RM₁ to RM₅:

RM₁=fa₁ (recoding date and time of metadata M11, recoding date and time of metadata M21)

RM₂=fa₂ (title of metadata M11, title of metadata M21)

RM₃=fa₃ (channel of metadata M11, channel of metadata M21)

RM₄=fa₄ (genre of metadata M11, genre of metadata M21)

RM₅=fa₅ (cast of metadata M11, cast of metadata M21)

For example, faₜ is a function that is larger for a smaller difference in recoding date and time between the metadata M11 and M21 and is smaller for a larger difference in the recoding date and time. More specifically, fa₁ may be represented by using a relational expression as follows:

MO1/|rec_data (M11)−rec_data (M21)|

where rec_data (x) is a function that uniquely converts recoding date and time of x into an integer, MO1 is an arbitrary constant number, and |X| is a function indicating the size of X and is typically an absolute value. Specifically, rec_data (x) is a function that converts the recoding date and time into an integer such as seconds having elapsed from a reference date and time determined as 0.

While an example is described above in which a function g represented as g(x) MO1/|X| is applied to fa₁ (M11, M21)=g(rec_data (M11)−rec_data (M21)), it is not so limited. The function g may be a function with L2 norm as, for example, g(x)=MO1/∥x∥. In this case, ∥x∥ is the square root of the sum of squares of the differences between elements that constitute x.

Other functions such as a sigmoid function and a gamma function may be applied to g(x). Besides, while an example is described above in which the function is larger as the recoding dates and times of the metadata M11 and M21 are closer, it is not so limited. The function may be smaller as the recoding dates and times of the metadata M11 and M21 are closer. Further, the function g may be large when a specific condition is satisfied.

For example, fa₂ is a function that is larger as more of the same letters or characters are contained in the character strings of the titles of the respective metadata M11 and M21. More specifically, if the title of the metadata M11 is “ABODE” and that of the metadata M11 is “FGCDH”, two letters “CD” are contained in both the titles. If the title of the metadata M11 is “ABODE” and that of the metadata M11 is “FGHIE”, one letter is contained in both the titles. Therefore, the value of fa₂ is larger in the former case. The relation may be determined based on a keyword contained in the brief description (subtitle) of a program in the same manner as the title basis.

While an example is cited above in which the number of the same letters or characters contained in both the titles are simply compared, this is not intended as a limitation. Additional conditions may be used such as that the function is larger as more of the same letters or characters are contained in both the titles from the top, or that even if no same letter is present in both the titles, when the titles have a common idea, they are determined to be the same. As an example of the latter case, a Japanese word “yakyu” is regarded as the same as “baseball”, and the titles that contain the words “yakyu” and “baseball”, respectively, are determined to contain the same character string.

Besides, when the titles have the same main character string and different sub character strings, they are likely to be of contents of the same series. Accordingly, in such a case, the value of fa₂ may be set to large. Specifically, for example, “ABCDE #2” and “ABCDE #3” are likely to be the titles of different episodes of the same drama series. Therefore, in such a case, the value of fa₂ may be doubled. Note that the above is described by way of example only, and the comparison as described above may be accomplished with high accuracy by commonly known technologies such as approximate pattern matching and regular expression matching.

For example, fa₃ is a function that is large when the metadata M11 and M21 are of contents of the same channel. Simply, fa₃ may be a function that takes value MO2 when the metadata M11 and M21 are of contents of the same channel and otherwise takes value 0. The value MO2 is an arbitrary constant number. In addition, if the metadata M11 and M21 are of contents of affiliate channels, the value of fa₃ may be set to a different value. For example, fa₃ may be a function that returns value MO2/2 when the metadata M11 and M21 are of contents of affiliate channels. Further, fa₃ may be a function that returns value MO2/4 if the metadata M11 and M21 are of contents of affiliate channels but of different broadcast media. Note that the above is described by way of example only, and fa₃ may be an arbitrary function.

For example, fa₄ is a function that is large when the metadata M11 and M21 are of contents of the same genre. More specifically, fa₄ may be a function that takes value MO3 if the metadata M11 and M21 both belong to the same genre “sports” and otherwise takes value 0. In addition, if the metadata M21 belongs to the subgenre of the metadata M11 such as, for example, if the metadata M11 belongs to the genre “sports” and the metadata M21 belongs to the genre “baseball”, fa₄ may be a function that takes value MO3/2. Further, even if the metadata M11 and M21 do not directly belong to the same genre, when they can be categorized in the same genre such as, for example, when the metadata M11 belongs to the genre “baseball” while the metadata M21 belongs to the genre “football” and the both are categorized in sports, fa₄ may be a function that takes value MO3/4. Note that the above is described by way of example only, and fa₄ may be an arbitrary function.

For example, fa₅ is a similar function to fa₄. More specifically, if the metadata M11 is of the content featuring “WW, XX, YY” and the metadata M21 is of the content featuring “XX, YY, ZZ”, then the same two persons are casted for both the contents. In such a case, fa₅ may be a function that takes value 2×MO4 (MO4: an arbitrary constant number), and it may be a function that takes value 0 if there is no same person casted for both the contents. Besides, someone in the cast may be a member of a group. For example, if a person KK is a member of a group XX, and when the metadata M11 is of the content featuring “VV, WW, XX” and the metadata M21 is of the content featuring “KK, YY, ZZ”, the person KK is casted in the content of M11 as a member of the group XX and also is casted in the content of M21. In such a case, fa₅ may be a function that returns value MO4/2.

In a similar fashion, the relation between groups or between people featured in the contents may be defined. For example, when the groups XX and YY belong to the same office, fa₅ may be a function that returns value MO4/4. In this case, the relation between a person and a group or between a person, a group and an office may be defined in the metadata or may be obtained from an external server (information site)

While an example is described above in which the relation is calculated not differentiating people in the cast list, this is not so limited. The relation may further be weighted according to the order on the cast list. For example, the derived relation is left as it is with respect to the first person on the cast list for the metadata M11, while it is weighted by ½ with respect to the second person and similarly is weighted by ⅓ with respect to the third person. The order on the cast list for the metadata M21 may also be taken into account in addition to that for the metadata M11. For example, if the second person on the cast list for the metadata M11 is the third person on the cast list for the metadata M21, the relation may be weighted by ½ with respect to the second person for the metadata M11 and may further be weighted by ⅓ with respect to the third person for the metadata M21. That is, the relation may be weighted by ½×⅓=⅙. Besides, the relation may be weighted differently with respect to a star playing a leading role based on information on the cast or the like. For example, the derived relation may be double-weighted with respect to the star.

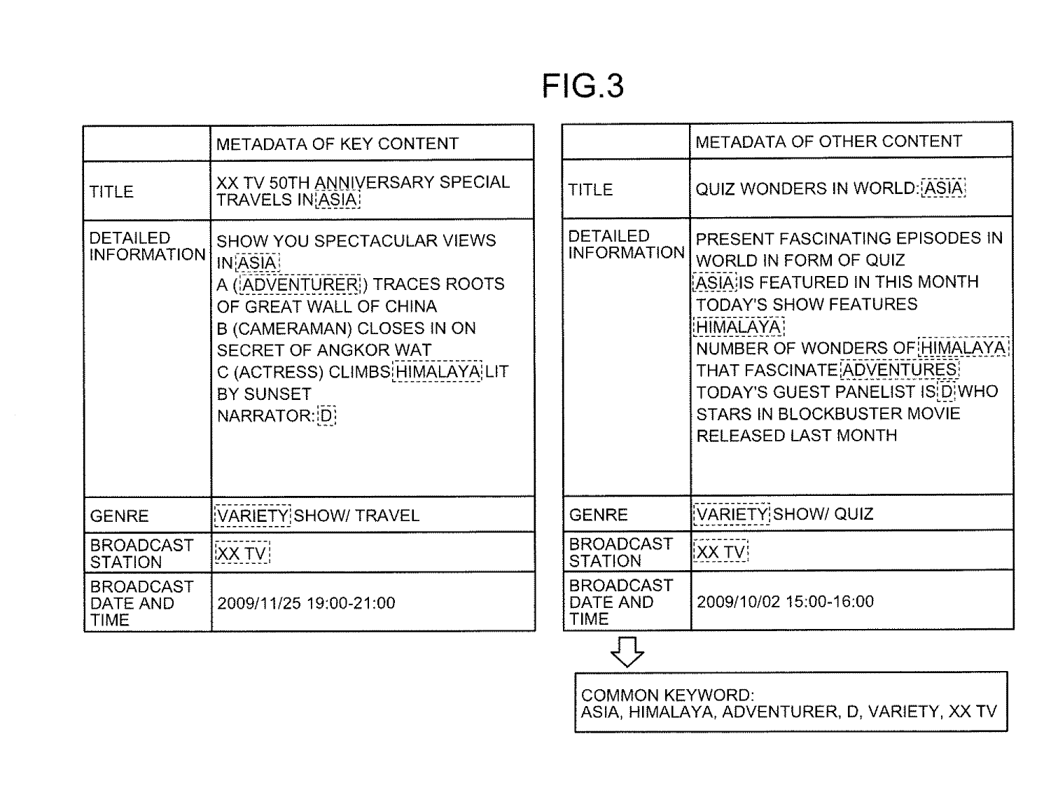

The keyword extractor 110 extracts, from the items related to the calculation of relation of other contents to key content, a common keyword contributing to the degree of relation for each of the other contents. More specifically, keywords that match between metadata of key content and that of another content are regarded as a common keyword. The common keyword may be a sentence or a word extracted from title, person's name, genre name, broadcast station, detailed information, and the like. Even if keywords do not completely match, when they indicate the same idea, such as “yakyu” and “baseball”, they are regarded as matching. An example of the common keyword will be described with reference to FIG. 3. FIG. 3 is a schematic diagram for explaining the common keyword. In the example of FIG. 3, among keywords contained in metadata of another content, metadata of key content contains “Asia”, “Himalaya”, “adventurer”, “D”, “variety”, and “XX TV”. Thus, in this case, the common keywords of the other content are “Asia”, “Himalaya”, “adventurer”, “D”, “variety”, and “XX TV”. In FIG. 3, the common keywords are each encircled by a virtual line for the sake of convenience of description. If there are a plurality of common keywords with respect to one content other than key content, the keyword extractor 110 determines the priority to display the common keywords in descending order of contribution to the relation to the key content. The keyword extractor 110 outputs the common keywords and priority information to the display information generator 105.

The display information generator 105 generates display information representing the details of the key content and the other contents based on the metadata of the key content and that of the other contents output from the metadata retriever 102. The display information generator 105 also generates keyword display information indicating the common keywords based on the common keywords and the priority information output from the keyword extractor 110. The display processing apparatus 100 is provided with two types of display modes, i.e., standard mode and search mode. The display information generator 105 generates different display information depending on the display modes. More specifically, in the standard mode, the display information generator 105 generates standard mode display information that does not contain the keyword display information. Meanwhile, in the search mode, the display information generator 105 generates search mode display information that contains the keyword display information. Besides, the display information generator 105 determines whether there is a representative image in content. According to the presence of a representative image, the display information generator 105 displays the display information of the content in different forms. The display information generator 105 searches metadata output from the metadata retriever 102 for a representative image, thereby determining whether there is a representative image. The display modes may be switched by a user through the input device.

More specifically, for example, based on the metadata of content of video data stored in the recorded program storage module 160, the display information generator 105 adds such items as a title to the representative image of the video data to generate display information to be displayed on the display module 170. Further, for example, based on the metadata of content of video data obtained from the IPTV server 200, the display information generator 105 adds such items as a title to the representative image of the video data to generate display information to be displayed on the display module 170. Still further, for example, based on the electronic program guide stored in the EPG storage module 150, the display information generator 105 generates display information to be displayed on the display module 170 to indicate the title of a TV program, the broadcast date and time, the channel, the brief description (subtitle) of the TV program, and the like.

The display information generator 105 also generates the keyword display information to display the common keywords extracted by the keyword extractor 110 on the display module 170. If there are a plurality of common keywords with respect to one content other than key content, the display information generator 105 arranges the common keywords in descending order of contribution to the relation to the key content. The display information generator 105 generates display information of contents other than key content each including corresponding keyword display information.

The standard mode display information is formed of only the display information, while the search mode display information is formed of the keyword display information in addition to the display information. That is, the standard mode display information mainly displays information on content such as the representative image, title, channel, genre, broadcast date and time, and the like of the content. On the other hand, the search mode display information displays a common keyword with emphasis thereon and only necessary information on content to identify the content (for example, only the title). The search mode display information may display only a common keyword. The common keyword may be displayed as text, an icon, an image, or the like. The display processing apparatus 100 is provided with a conversion table in which each keyword is associated with an icon, an image, or the like. The display information generator 105 converts a common keyword into an icon, an image, or the like based on the conversion table.

The standard mode display information and the search mode display information of content will be described in detail. FIGS. 4A and 4B are schematic diagrams of the standard mode display information. FIGS. 4C and 4C are schematic diagrams of the search mode display information. In the display information, pieces of information are arranged in a rectangular area.

FIG. 4A illustrates standard mode display information C of content generated based on metadata of video data stored in the recorded program storage module 160. Incidentally, if it is not necessary to distinguish between key content and other contents, the standard mode display information is denoted by C, while if it is necessary, the standard mode display information is denoted by, for example, C1. As illustrated in FIG. 4A, in the standard mode display information C, the representative image of content is displayed in a thumbnail view in an area Ca, the title of the content (video) such as, for example, “xxxx researchers, 5th in series featuring Kyusyu” is displayed in an area Cb, and other information on the content is displayed as a thumbnail, text, or the like in an area Cc. Examples of the other information on the content include broadcast station, genre, broadcast date and time, recording date and time, and the like. FIG. 4B illustrates standard mode display information C of content generated based on an electronic program guide. As illustrated in FIG. 4B, in the standard mode display information C, the broadcast date and time of the content is displayed in the area Ca, the title of the content is displayed in the area Cb, and other information on the content is displayed as a thumbnail, text, or the like in the area Cc. In this manner, according to the first embodiment, if there is the representative image of content, the representative image is displayed in the area Ca of the standard mode display information C as illustrated in FIG. 4A. On the other hand, if there is no representative image of content, the broadcast date and time of the content is displayed in the area Ca of the standard mode display information C as illustrated in FIG. 48.

FIG. 4C illustrates search mode display information CA of content generated based on metadata of video data stored in the recorded program storage module 160. Incidentally, if it is not necessary to distinguish between key content and other contents, the search mode display information is denoted by CA, while if it is necessary, the search mode display information is denoted by, for example, CA1. As illustrated in FIG. 4C, the search mode display information CA contains keyword display information D. More specifically, in the search mode display information CA, common keywords (for example, Kyusyu, research, local dishes, hot springs) are displayed by the keyword display information D in an area CAa, the title of the content (video) such as, for example, “xxxx researchers, 5th in series featuring Kyusyu” is displayed in an area CAb, and other information on the content is displayed as a thumbnail, text, or the like in an area CAc. The common keywords in the keyword display information D are arranged from the left to the right from the first to the second line in descending order of contribution to the relation to key content. In the example of FIG. 4C, the common keywords are displayed in the order of “Kyusyu”, “research”, “local dishes”, and “hot springs”. Examples of the other information on the content include broadcast station, genre, broadcast date and time, recording date and time, and the like. An example of search mode display information CA illustrated in FIG. 40 is basically similar to that of FIG. 4C except that part of the common keywords in the keyword display information D is represented by an icon Da.

The display controller 106 reproduces and displays content output from the video reproducer 107 on the display module 170.

As described above, when the operation receiver 101 receives an instruction from a user to retrieve content, the display controller 106 displays list information indicating a list of display information of key content and that of other contents related to the key content on the display module 170 to allow the user to retrieve the content. In the standard mode, the display controller 106 displays list information using the standard mode display information (hereinafter, “standard mode list information”). On the other hand, in the search mode, the display controller 106 displays list information using the search mode display information (hereinafter, “search mode list information”). In the search mode list information, the display controller 106 displays a common keyword contained in another content than the key content in association with the display information of the other content.

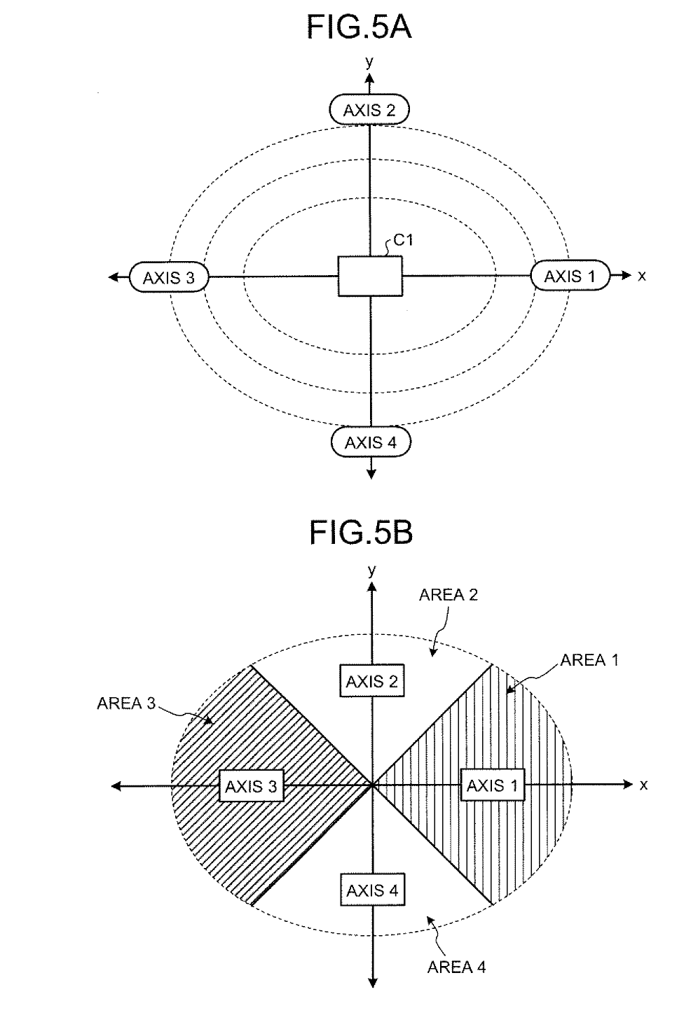

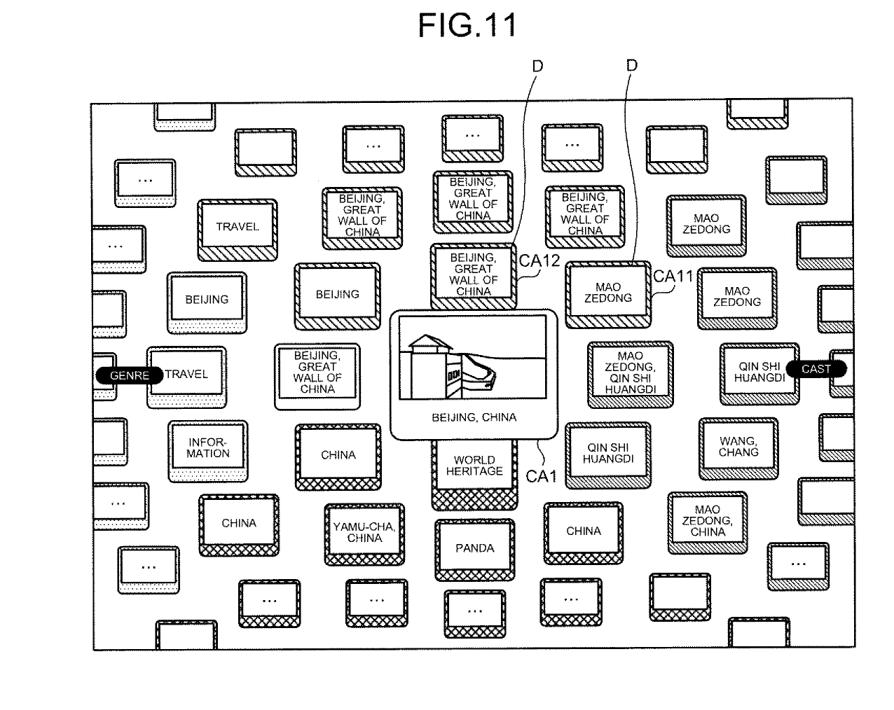

While the standard mode list information and the search mode list information are different in display information of contents, they are the same in arrangement of pieces of display information of key content and other contents. Accordingly, when the standard mode list information and the search mode list information need not be distinguished from each other, they are simply referred to as “list information”. In the list information, the display information of the key content is arranged in a desired position. With the position of the display information of the key content as the center, pieces of the display information of the other contents are arranged to form concentric polygons, for example, correspondingly to the directions of operation on an operation button such as an arrow key on the remote controller 90 or the keyboard. The screen is divided into predetermined areas for respective items in radial directions from the center. The pieces of the display information of the other contents are arranged in the predetermined areas such that the one with higher relation is closer to the center. Additionally, in the list information, the display information of the key content is displayed in the largest size, and the display information of the other contents is displayed smaller as the distance from the center increases. A description will be given of the operation of displaying the display information. FIGS. 5A to 11 are schematic diagrams for explaining the operation of displaying the display information, FIGS. 5A to 10 illustrate the standard mode list information as examples of the list information. FIG. 11 illustrates an example of the search mode list information including search mode display information CA1 of key content, and search mode display information CA11 and CA12 of other contents. In FIG. 5A and the following figures, the standard mode display information C and the search mode display information CA are illustrated in a simplified manner.

As illustrated in FIG. 5A, the display controller 106 arranges display information C1 of the key content at a desired position. The display controller 106 then sets, using the position of the display information C1 as the center, four axes (axes to 4) in the positive x-axis direction, the positive y-axis direction, the negative x-axis direction, and the negative y-axis direction, respectively. Thereafter, the display controller 106 assigns each item contained in the metadata of the selected key content to one of the four axes. Referring to FIG. 2, as items contained in the metadata, the “title” of a TV program (content), the “cast” of the TV program, a “keyword” for search contained in the brief description of the TV program, and the “genre” of the TV program are each assigned to one of the four axes. A user can use the items assigned to the axes as indices for searching for contents related to the key content.

As illustrated in FIG. 5B, the display controller 106 divides the display area into predetermined areas (areas 1 to 4) in radial directions from the display information C1 in the center. The display area is divided at an arbitrary angle, for example, an angle of 90°, such that each of the predetermined areas includes one of the axes assigned one of the items. In this manner, the display controller 106 generates the predetermined areas (area 1 to 4) each including one of the axes.

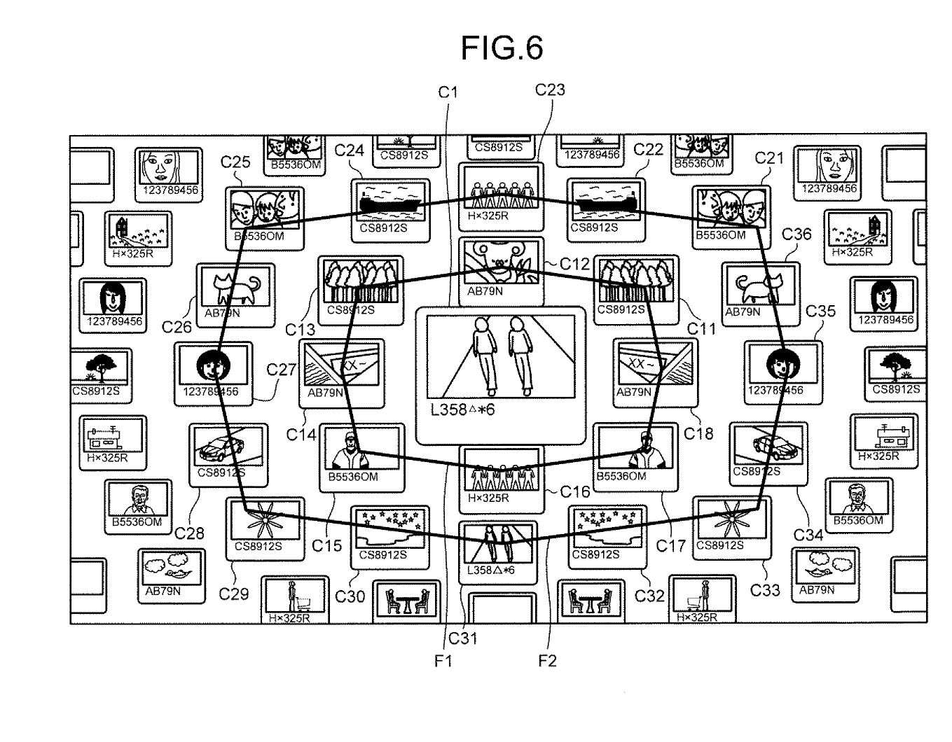

As illustrated in FIG. 6, the display controller 106 arranges pieces of display information of other contents on a plurality of octagons F1, F2, . . . , which are concentrically formed around the display information C1 of the key content as the center, correspondingly to up, down, left, and right directions of the operation button on the remote controller 90 or the keyboard. More specifically, the display controller 106 arranges eight pieces of display information C11 to C18 of other contents on the corners of the octagon F1. Further, the display controller 106 arranges on the corners of the octagon F2 eight pieces of display information C21, C23, C25, C27, C29, C31, C33, and C35 of other contents, and also eight pieces of display information C22, C24, C26, C28, C30, C32, C34, and C36 of other contents between the respective pieces along the directions of operation. In the same manner as just described, the display controller 106 arranges on the corners of each octagon eight pieces of display information of other contents, and also eight pieces of display information of other contents between the respective pieces. With this arrangement of display information of other contents, with respect to any piece of display information, other pieces of display information are arranged along the up, down, left, or right directions of operation.

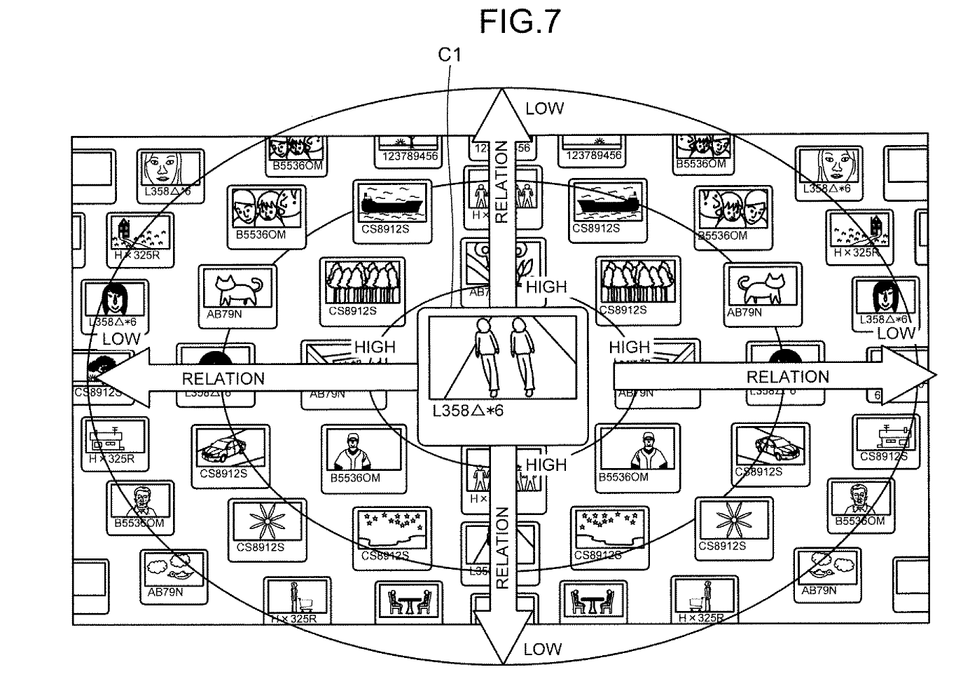

At this time, as illustrated in FIG. 7, the display controller 106 arranges pieces of display information of other contents with higher relation to the key content closer to the center at which is arranged the display information C1 of the key content. In other words, pieces of display information of other contents with lower relation to the key content are arranged more distant from the center. That is, in the example of FIG. 6, the display controller 106 arranges pieces of display information of other contents with the highest relation to the key content on the octagon F1. The display controller 106 also arranges pieces of display information of other contents in descending order of relation to the key content on the octagon F2, and other octagons (not illustrated).

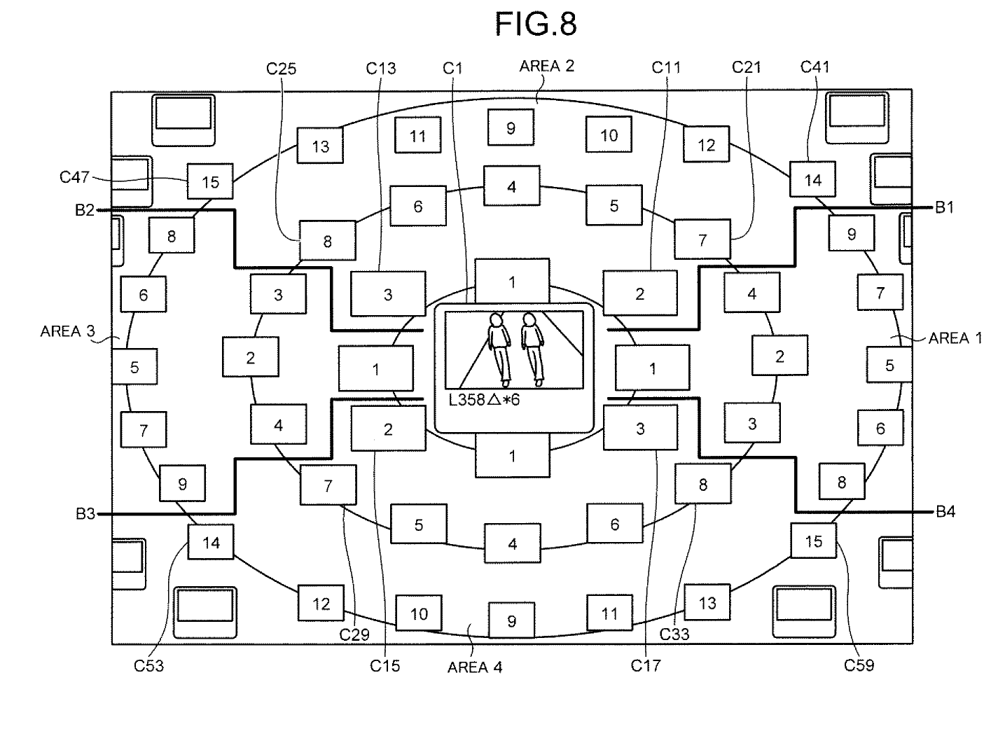

In addition, the display controller 106 arranges pieces of display information of other contents in descending order of relation to the key content in each of the predetermined areas previously obtained for each item. That is, the display controller 106 classifies the display information of other contents by the items assigned to the areas (axes), respectively. More specifically, as illustrated in FIG. 8, for respective items assigned to the area 1 defined by boundary lines B1 and B4, the area 2 defined by boundary lines B1 and B2, the area 3 defined by boundary lines B2 and B3, and the area 4 defined by boundary lines B3 and B4, the display controller 106 arranges pieces of display information of other contents in the order of numbers assigned to the pieces in FIG. 8. Thus, with respect to each of the items, the pieces of the display information of the other contents can be arranged from around the center in descending order of relation to the key content.

In the example of FIG. 8, pieces of the display information C11, C21 and C41 are located in positions capable of belonging to both the areas 1 and 2. For example, the pieces of the display information C11, C21 and C41 may be set to belong to either one of the areas or items in which more contents with relation to the key content higher than a predetermined threshold are present than in the other. In FIG. 8, since more other contents with relation higher than the predetermined threshold are present in the area 2 than in the area 1, the pieces of the display information C11, C21 and C41 belong to the area 2. The same is applied to pieces of the display information C13, C25, C47, C15, C29, C53, C17, C33, and C59.

While an area to which display information displayed near a boundary line belongs is described above as being determined based on the degree of relation to the key content, this is by way of example and not of limitation. For example, display information displayed near a boundary line may belong to an area having more contents related to the key content than the other.

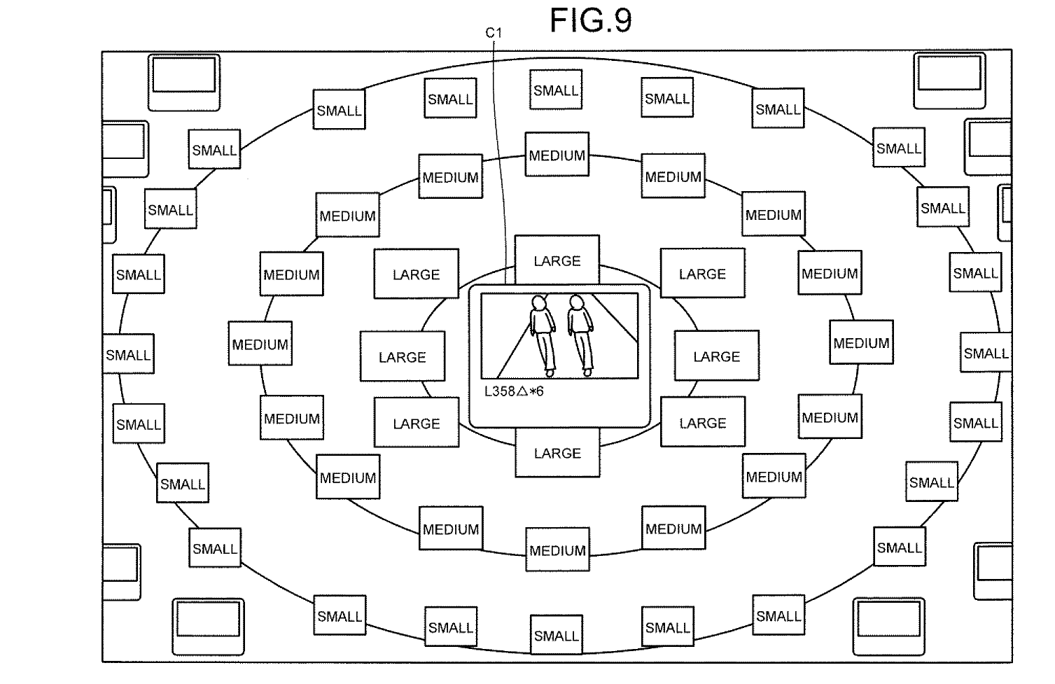

Further, as illustrated in FIG. 9, the display controller 106 displays the display information of the key content in the largest size, and the display information of the other contents smaller as the distance from the center increases.

When display information of another content than the key content belongs to a plurality of areas, the display controller 106 displays the display information in one of the areas so that the same display information is not displayed concurrently in the different areas. More specifically, when display information of the other content belongs to the areas 1 and 2, the display information is displayed in only one area assigned an item with respect to which the other content has higher relation to the key content.

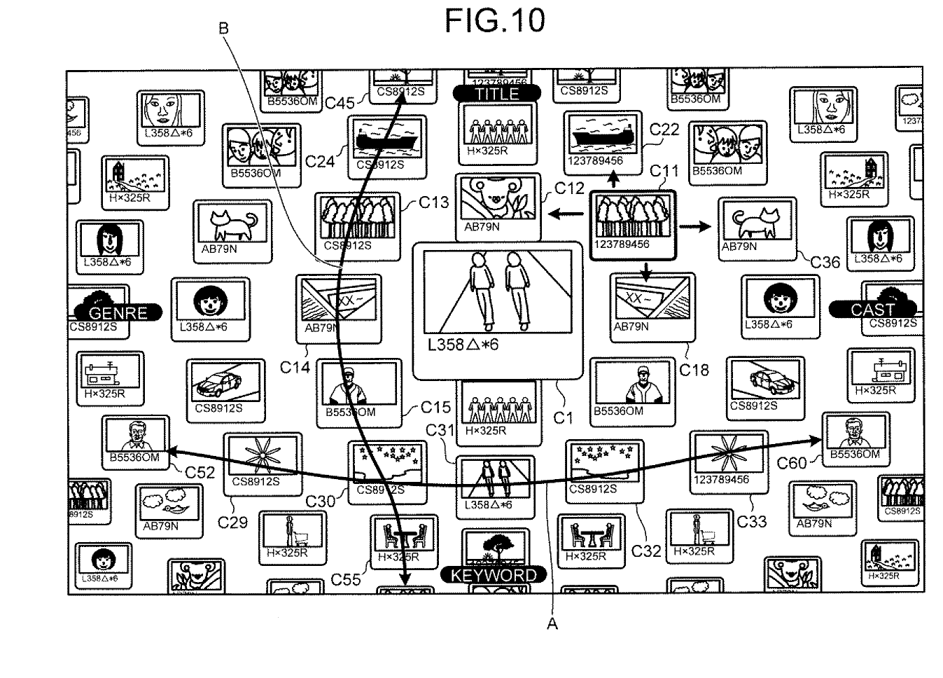

In this manner, the display controller 106 generates list information in which are arranged the display information C1 of the key content and the display information C11, . . . of the other contents, and displays the list information on the display module 170. Incidentally, the display controller 106 stores in advance the display position and size of the display information, and, after the calculation of the relation to the key content, sequentially arranges pieces of the display information of the other contents each in a predetermined size. FIG. 10 illustrates an example of the standard mode list information in which are arranged the standard mode display information C1 of the key content and the standard mode display information C11, . . . of the other contents. In the standard mode list information of FIG. 10, items “Title”, “Cast”, “Keyword”, and “Genre” are displayed on the upside, right side, downside, and left side of the screen, respectively. Further, with the standard mode display information C1 of the key content as the center, pieces of the standard mode display information of the other contents are arranged from around the center toward the outside.

As described above, according to the first embodiment, pieces of display information of other contents than key content are arranged along up, down, left, and right directions of operation. Therefore, in the example of FIG. 10, if the display information C30 is focused content for search, upon receipt of an instruction for left-right movement through the operation button on the remote controller 90 or the keyboard, the focus on the display information C30 moves in directions indicated by a double-head arrow A. Similarly, if the display information C30 is focused content for search, upon receipt of an instruction for up-down movement through the operation button, the focus on the display information C30 moves in directions indicated by a double-head arrow B. Additionally, for example, if the cursor moves one space to the right in response to an instruction when the focus is on the display information C11, the focus moves to the display information C36. Similarly, if the cursor moves one space in the up, left, or down direction in response to an instruction, the focus moves from the display information C11 to the display information C22, C12, or C18. Thus, the operation using the operation button such as an arrow key on the remote controller 90 or the keyboard can be facilitated.

In the standard mode, the display controller 106 displays the standard mode list information using the standard mode display information on the display module 170 as illustrated in FIG. 6. Meanwhile, in the search mode, the display controller 106 displays the search mode list information using the search mode display information on the display module 170 as illustrated in FIG. 11. If the list information is switched between the standard mode list information and the search mode list information, the arrangement of contents or their display information displayed therein does not change. Thus, the display controller 106 displays the keyword display information D contained in the search mode display information of content in association with the standard mode display information. In the list information, pieces of display information of other contents with higher relation to key content are arranged closer to the key content. Besides, the search mode list information contains the keyword display information D. Accordingly, the search mode list information is displayed on the display module 170 that contains the keyword display information D as well as the list information in which pieces of display information of other contents with higher relation to key content are arranged closer to the key content.

The display controller 106 may display different common keywords in the keyword display information D in different colors. In FIG. 11, for example, common keywords “Beijing” and “China” in the keyword display information D of search mode display information CA1 may be displayed in red and blue, respectively.

The display mode setting module 111 sets the display mode to either one of the standard mode or the search mode. The display mode setting module 111 may set the display mode to the standard mode by, for example, not setting a flag in a display mode flag area provided in a display device. On the other hand, the display mode setting module 111 may set the display mode to the search mode by setting the flag in the display mode flag area. If a user selects either one of the standard mode or the search mode as the display mode with an operation button on the input device, and the operation receiver 101 receives the selection, the display mode setting module 111 sets the display mode to the selected mode. A display mode selection menu screen may be displayed on the display module 170 to allow the user to select the display mode from the display mode selection menu screen using the input device. The display mode setting module 111 may switch the display mode to a predetermined mode in response to user's operation through the input device such as to change focused content.

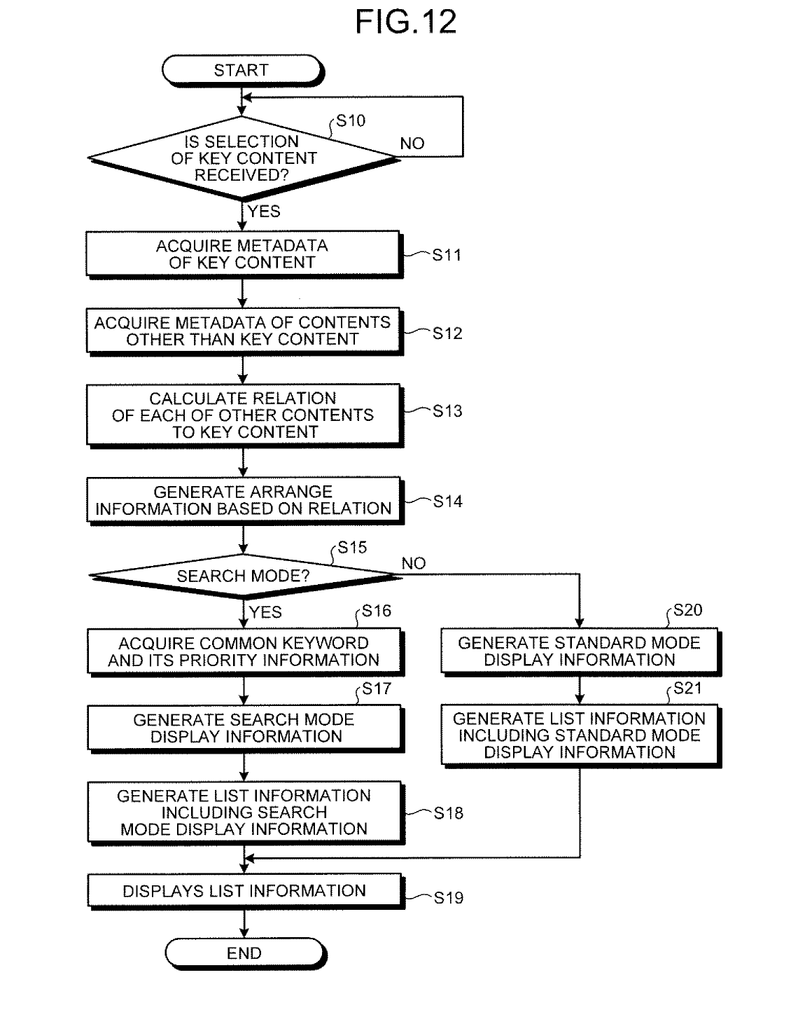

A description will now be given of the process of displaying display information performed by the display processing apparatus 100. FIG. 12 is a flowchart of the process of displaying the display information performed by the display processing apparatus 100.

The operation receiver 101 waits for receiving the selection of key content thorough the input device (S10). Upon receipt of the selection (Yes at S10), the metadata acquiring module 103 acquires metadata of the key content (S11). The metadata acquiring module 103 then acquires metadata of contents other than the key content (S12).

The relation calculator 104 calculate the relation of the other contents to the key content with respect to each item contained in the metadata (S13). The display controller 106 generates arrange information to arrange display information of the key content and that of the other contents such that pieces of the display information of the other contents are arranged according to their relation to the key content (S14).

When the display mode setting module 111 has set the display mode to the search mode (Yes at S15), the display information generator 105 acquires a common keyword and its priority information (S16), and generates the search mode display information (S17). The display controller 106 then generates list information (search mode list information) in which is arranged the search mode display information (S18), and displays the list information on the display module 170 (S19).

On the other hand, when the display mode setting module 111 has set the display mode to the standard mode (No at S15), the display information generator 105 generates the standard mode display information (S20). The display controller 106 then generates list information (standard mode list information) in which is arranged the standard mode display information (S21), and displays the list information on the display module 170 (S19).

Further, the display controller 106 comprises a scrolling module (not illustrated) and has the following functions. When the operation receiver 101 receives an instruction to specify display information of focused content through the input device, the scrolling module scrolls the list information in the operation direction in a predetermined display range. At this time, regardless of the movement amount of the list information due to scrolling by the scrolling module, the display controller 106 maintains display information of key content to be displayed in the display range. Besides, the display controller 106 displays the display information of the focused content specified from other contents than the key content by the operation with the input device in such a manner that the display information of the focused content is larger than that of the other contents not specified.

As described above, according to the first embodiment, the display processing apparatus 100 comprises the display controller 106 that displays list information, in which pieces of display information of other contents than key content with higher relation to the key content are arranged closer to the key content, on the display module 170. The display controller 106 displays the keyword display information D of other content than the key content in association with the display information of the other contents in the list information. This enables a user to recognize the relation between the key content and the other contents based on a common keyword contained in the keyword display information D and thereby to understand the details of the contents. Thus, the user can retrieve content related to the key content from various contents by using the input device.

Moreover, according to the first embodiment, if there are a plurality of common keywords with respect to one content other than key content, the display information generator 105 arranges the common keywords in descending order of contribution to the relation to the key content. Thus, it is possible to preferentially provide a user with common keywords highly contributing to the relation to the key content.

Furthermore, according to the first embodiment, the display information generator 105 generates display information of contents other than key content each including corresponding keyword display information. Thus, a user can instinctively recognize the keyword display information of each content.

Still further, according to the first embodiment, in the standard mode, the display controller 106 displays list information using the standard mode display information. On the other hand, in the search mode, the display controller 106 displays list information using the search mode display information. Thus, it is possible to selectively provide a user with two different types of display information. The two display modes enables necessary information to be displayed in a limited display area for any purpose. More specifically, the search mode allows a user to recognize a common keyword and facilitates the retrieval of content related to key content. The standard mode allows a user to easily recognize the details of content.

Still further, according to the first embodiment, the display controller 106 may display different common keywords in the keyword display information D in different colors, i.e., the same common keywords in the same color. Thus, a user can easily recognize contents having the same common keyword.

Still further, according to the first embodiment, the display information generator 105 determines whether there is a representative image in content. According to the presence of a representative image, the display information generator 105 displays the display information of the content in different forms. Thus, it is possible to provide a user with the display information of content according to the presence of a representative image.

The computer program (hereinafter, “display processing program”) may be executed on a computer to realize the same function as the display processing apparatus 100. The display processing program may be provided to the computer as being stored in a computer-readable storage medium, such as a compact disc-read only memory (CD-ROM), a flexible disk (FD), a compact disc recordable (CD-R), and a digital versatile disc (DVD), as a file in an installable or executable format.

The display processing program may also be stored in a computer connected via a network such as the Internet so that it can be downloaded therefrom via the network. The display processing program may also be provide or distributed via a network such as the Internet.

The display processing program may also be provided as being stored in advance in ROM or the like. The display processing program comprises modules that implement the above constituent elements (the operation receiver 101, the metadata retriever 102, the metadata acquiring module 103, the relation calculator 104, the display information generator 105, the display controller 106, the video reproducer 107, the broadcast receiver 108, the keyword extractor 110, and the display mode setting module 111). As real hardware, the CPU (processor) loads the display processing program from the storage medium as described above into the main memory and executes it. With this, the constituent elements, such as the operation receiver 101, the metadata retriever 102, the metadata acquiring module 103, the relation calculator 104, the display information generator 105, the display controller 106, the video reproducer 107, the broadcast receiver 108, the keyword extractor 110, and the display mode setting module 111, may be implemented on the main memory.

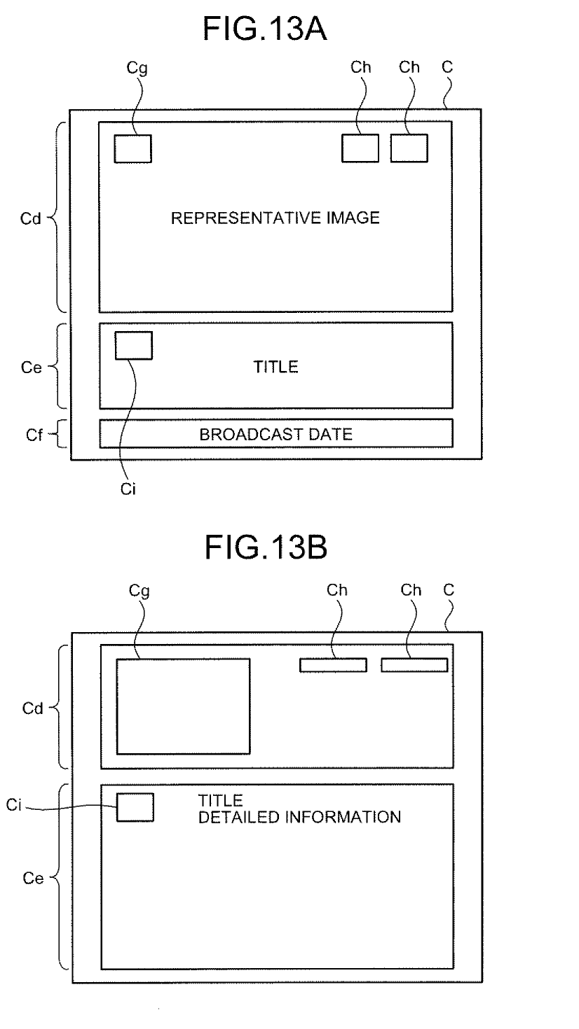

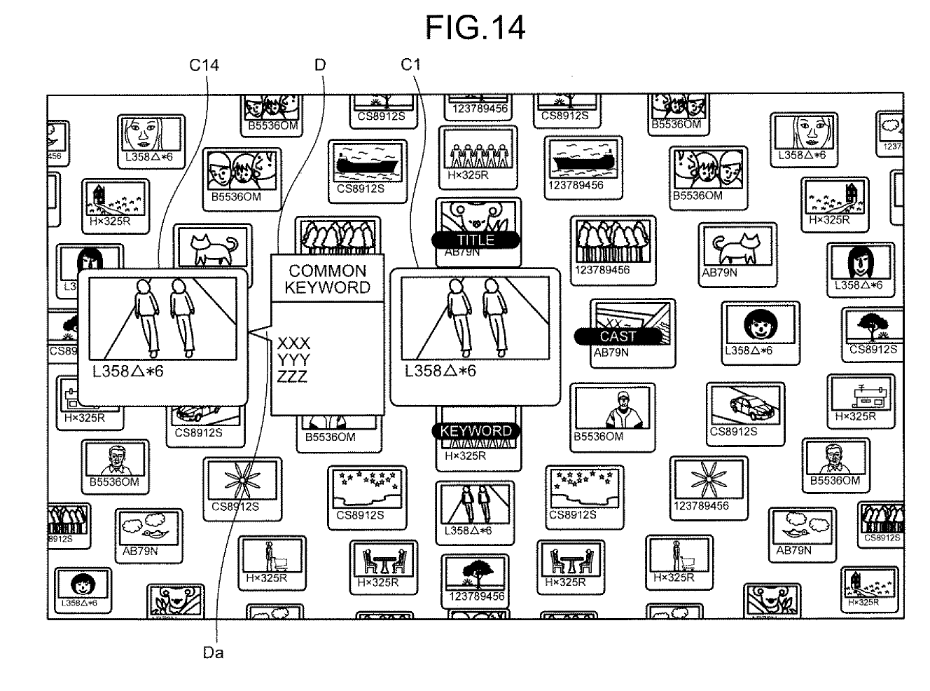

In the following, a modification of the first embodiment will be described with reference to FIGS. 13A and 13B. FIG. 13A is a schematic diagram of display information of content according to the modification. FIG. 13B is a schematic diagram of display information of content when the content has no representative image according to the modification. According to the modification, in standard mode display information C of content having a representative image, as illustrated in FIG. 13A, the representative image of the content is displayed in a thumbnail view in an area Cd, the title of the content (video) is displayed in an area Ce, and the broadcast date of the content is displayed in an area Cf. In addition, a genre icon Cg is displayed at the upper left corner of the area Cd, while icons Ch are displayed at the upper right corner of the area Cd. The icons Ch each indicate broadcast station, channel, video on demand (VOD), provider, or the like. Although the two icons Ch are illustrated in FIG. 13B, there may be one, three or more of the icons Ch. Further, an icon Ci is displayed in the area Ce. The icon Ci indicates whether timer recording or viewing has been programmed. In the in standard mode display information C, the areas Cd, Ce, and Cf become smaller in this order.

On the other hand, in standard mode display information C of content having no representative image, as illustrated in FIG. 13B, the genre icon Cg, the icons Ch, and the broadcast date and time of the content are displayed in the area Cd, and the title and the detailed information of the content (video) are displayed in the area Ce. Further, the icon Ci is displayed in the area Ce. The genre icon Cg in this standard mode display information C is larger than that of the standard mode display information C of the content having a representative image illustrated in FIG. 13A. In the standard mode display information C of content having no representative image, the area Cd is smaller than that of the standard mode display information C of the content having a representative image (see FIG. 13A). In contrast, the area Ce is larger than that of the standard mode display information C of the content having a representative image (see FIG. 13A). The standard mode display information C of content having no representative image is not provided with the area Cf that is provided to the standard mode display information C of the content having a representative image (see FIG. 13A).

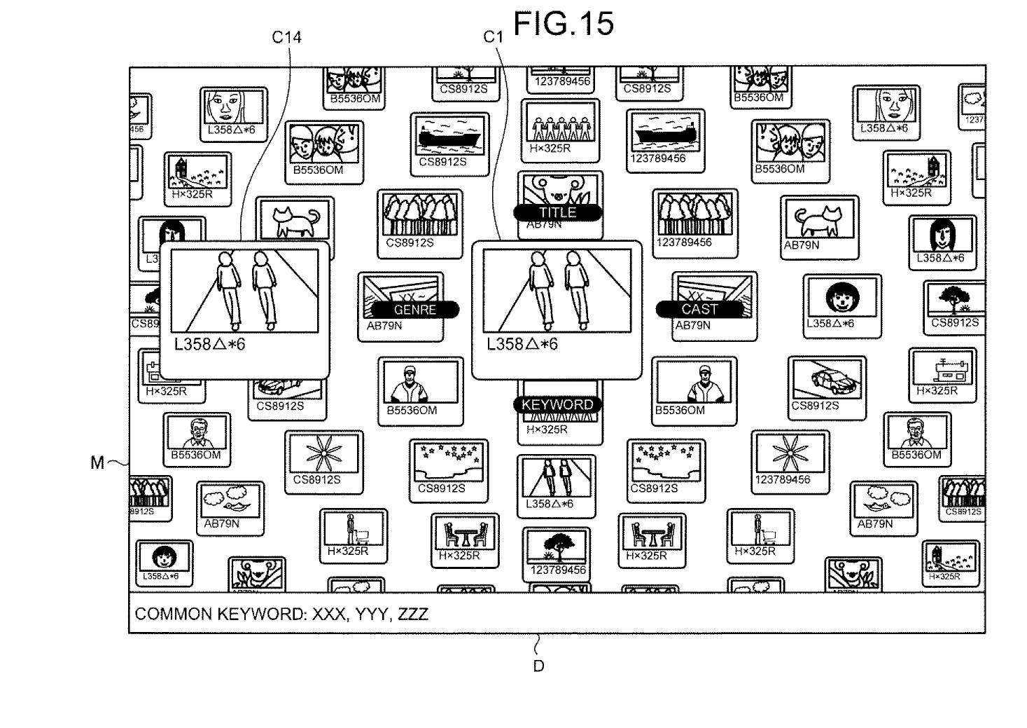

A second embodiment of the invention will be described with reference to FIGS. 14 and 15. FIGS. 14 and 15 are schematic diagrams of examples of list information according to the second embodiment. Elements corresponding to those of the first embodiment are designated by the same reference numerals or characters, and their description will not be repeated.

The second embodiment is in many respects similar to the first embodiment except for keyword display information.

According to the second embodiment, the operation receiver 101 receives operation to display keyword display information corresponding to specific content other than key content. When the operation receiver 101 receives operation to display keyword display information corresponding to specific content other than key content, the display controller 106 displays keyword display information for only display information of the specific content among a plurality of contents in list information. More specifically, a user provides the operation to display keyword display information corresponding to specific content other than key content through the input device by, for example, selecting display information of focused content. In the examples of FIGS. 14 and 15, display information C14 of content is selected as display information of focused content. FIGS. 14 and 15 each illustrate an example of list information in which items “title”, “cast”, “keyword”, and “genre” are arranged close to display information of key content.

As illustrated in FIGS. 14 and 15, the display controller 106 displays the keyword display information C for only the display information C14 of specific content among a plurality of pieces of display information of contents in the list information. At this time, the display controller 106 displays the keyword display information D at a different position than the position of the display information C14 of the specific content corresponding thereto. In the example of FIG. 14, the keyword display information 9 is displayed around the display information C14 of the specific content corresponding thereto, for example, at a side of the display information C14. In the keyword display information 9 illustrated in FIG. 14, common keywords (∘∘∘, ΔΔΔ, xxx) are arranged each on one line in descending order of priority from the top to the bottom. The keyword display information D has a triangular pointer Da pointing the display information C14 of the specific content corresponding thereto. In the example of FIG. 15, the keyword display information 9 is displayed outside, as an example, below list information M. In the keyword display information D illustrated in FIG. 15, common keywords (∘∘∘, ΔΔΔ, xxx) are arranged in a line in descending order of priority from the left to the right.

The common keyword display information D is generated by the display information generator 105 and arranged at a predetermined position by the display controller 106. When focused content changes to another, the display controller 106 displays the keyword display information 9 of the new focused content and does not display that of the former focused content.

As described above, according to the second embodiment, when the operation receiver 101 receives operation to display keyword display information corresponding to specific content other than key content, the display controller 106 displays keyword display information for only display information of the specific content. Thus, information desired by a user can be displayed in such a manner that the user can easily recognize the information.

Moreover, according to the second embodiment, the display controller 106 displays the keyword display information at a different position than the position of display information of the specific content corresponding thereto. Thus, information desired by a user can be displayed in such a manner that the user can easily recognize the information.

Furthermore, according to the second embodiment, the keyword display information has a pointer pointing the display information of the specific content corresponding thereto. The display controller 106 displays the keyword display information around the display information of the specific content corresponding thereto. Thus, a user can instinctively recognize display information of content corresponding to keyword display information.

Still further, according to the second embodiment, the display controller 106 displays the keyword display information outside list information. Thus, there is no need to change the list information depending on the display mode. In other words, standard mode list information can be used even in the search mode.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display processing apparatus comprising:
an operation receiver configured to receive operation to select key content of a first type as a search key;
a relation calculator configured to calculate relation of each of second contents to the key content, the second contents being of a plurality of types including a second type different from the first type;
a keyword extractor configured to extract a common keyword contributing to the relation from items related to calculation of the relation with respect to each of the second contents;
a display information generator configured to generate display information including first display information of the key content and second display information of each of the second contents, and keyword display information indicating the common keyword; and
a display controller configured to display, on a display device, list information, in which pieces of the second display information are arranged such that second display information of second content with higher relation to the key content is closer to the first display information, wherein
the display controller is configured to display the keyword display information of each of the second contents in the list information in association with the second display information of the second content.

2. The display processing apparatus of claim 1, wherein, when there are a plurality of common keywords with respect to one second content, the display information generator arranges the common keywords in descending order of contribution to the relation.

3. The display processing apparatus of claim 1 further comprising a display mode setting module configured to set either one of standard mode and search mode as display mode, wherein
the display information generator is configured to generate standard mode display information not including the keyword display information and search mode display information including the keyword display information as the display information,
the display controller is configured to display the list information using the standard mode display information in the standard mode, and
the display controller is configured to display the list information using the search mode display information in the search mode.

4. The display processing apparatus of claim 1, wherein
the operation receiver is configured to receive operation to display keyword display information corresponding to second display information of specific second content, and
when the operation receiver receives the operation to display keyword display information corresponding to second display information of specific second content, the display controller displays the keyword display information for only the second display information of the specific second content among the pieces of the second display information of the second contents in the list information.

5. The display processing apparatus of claim 4, wherein the display controller is configured to display the keyword display information at a position different from where the second display information of the specific second content is displayed.

6. The display processing apparatus of claim 5, wherein
the keyword display information comprises a pointer configured to point the second display information of the specific second content, and
the display controller is configured to display the keyword display information around the second display information of the specific second content.

7. The display processing apparatus of claim 5, wherein the display controller is configured to display the keyword display information outside the list information.

8. The display processing apparatus of claim 1, wherein the display controller is configured to display different common keywords in the keyword display information in different colors.

9. The display processing apparatus of claim 1, further comprising a metadata acquiring module configured to acquire first metadata of the key content and second metadata of each of the second contents, wherein
the relation calculator is configured to calculate the relation based on the first metadata and the second metadata, and
the display controller is configured to display the list information divided into areas, each corresponding to one of the items, radially from the first display information as a center, the pieces of the second display information each arranged in corresponding one of the areas.

10. The display processing apparatus of claim 1, wherein the display information generator is configured to determine whether there is a representative image in content and, according to presence of a representative image, display the display information of the content in different forms.

11. A computer program product comprising a computer usable medium having computer readable program codes embodied in the medium that, when executed, causes a computer to implement:
an operation receiver configured to receive operation to select key content of a first type as a search key;
a relation calculator configured to calculate relation of each of second contents to the key content, the second contents being of a plurality of types including a second type different from the first type;
a keyword extractor configured to extract a common keyword contributing to the relation from an item related to calculation of the relation with respect to each of the second contents;
a display information generator configured to generate first display information of the key content and second display information of each of the second contents, and keyword display information indicating the common keyword; and
a display controller configured to display list information, in which pieces of the second display information are arranged such that second display information of second content with higher relation to the key content is closer to the first display information, wherein
the display controller is configured to display the keyword display information of each of the second contents in the list information in association with the second display information of the second content.

12. A display processing method applied to a display processing apparatus comprising a controller and a storage module, the display processing method performed by the controller and comprising:
an operation receiver receiving operation to select key content of a first type as a search key;
a relation calculator calculating relation of each of second contents to the key content, the second contents being of a plurality of types including a second type different from the first type;
a keyword extractor extracting a common keyword contributing to the relation from an item related to calculation of the relation with respect to each of the second contents;
a display information generator generating first display information of the key content and second display information of each of the second contents, and keyword display information indicating the common keyword; and
a display controller displaying list information, in which pieces of the second display information are arranged such that second display information of second content with higher relation to the key content is closer to the first display information, wherein
the display controller is configured to display the keyword display information of each of the second contents in the list information in association with the second display information of the second content.
